(19) United States
(12) Patent Application Publication
(10) Pub. No.: US 2008/0148696 A1
(43) Pub. Date: Jun. 26, 2008

(54) Air purifier with housing simulating an animate object

(76) Inventor: Dirk Niedermann, Bloomingdale, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/644,460

(22) Filed: Dec. 22, 2006

(51) Int. Cl. B01D 46/42; B01D 50/00

(52) U.S. Cl. 55/357; 55/385.4; 55/383

(57) ABSTRACT

A purifier for air having a housing and at least one component on the housing for changing a characteristic of air in a space within which the air purifier resides. The housing has an external surface that is shaped to simulate the appearance of an animate object.

### BACKGROUND OF THE INVENTION

1. Field of the Invention

This invention relates to purifiers for room air and, more particularly, to a purifier having at least one operating component contained within a housing that simulates the appearance of an animate object.

2. Background Art

Room air purifiers are becoming increasingly popular in the home environment. Airborne contaminants represent a health risk, particularly for young children, and more significantly for those with respiratory conditions, such as asthma, and the like. Contaminants entrained in room air are particularly a problem with forced air systems that cause such contaminants to permeate substantially the entire volume of a confined space.

This has lead to the development of different types of room air purifiers that treat a discrete amount of air within a space occupied by an individual or individuals that are particularly sensitive to airborne contaminants. It is also considered a good practice to remove such contaminants in the rooms of young children, regardless of their physical health.

Air purifiers sold in large volume for residential use generally have a housing with a simple geometric shape, such as a cylinder, cube, or the like. While these shapes are functional, they are generally lacking in aesthetic appeal and may stand out, particularly in a child's room that is decorated with an overall youthful theme. The aesthetic shortcomings of these purifiers may dictate a decision on the part of a parent not to place the same directly in a child's room.

The industry continues to seek out ways to encourage consumers to purchase air purifiers, particularly for rooms occupied by children and those that may be sensitive to airborne contaminants. The absence of an effective way of doing so to date has resulted in the inability of many young children to realize the benefits of purified room air.

### SUMMARY OF THE INVENTION

In one form, the invention is directed to a purifier for air having a housing and at least one component on the housing for changing a characteristic of air in a space within which the air purifier resides. The housing has an external surface that is shaped to simulate the appearance of an animate object.

The housing may be shaped to simulate the appearance of an animal, such as one that lives either on land, or in or around water.

In one form, the housing has a top and bottom. The animal has a head and tail/feet. The housing external surface is shaped to simulate the appearance of: a) the animal's tail/feet at the bottom of the housing; and b) the animal's head at the top of the housing.

As just examples, the animal may be one of: a) a shark; b) a whale; and c) a penguin.

In one form, the housing defines an internal compartment within which the at least one component resides.

In one form, the housing has a lower inlet vent and an upper outlet vent that are in communication with the internal compartment so that: a) untreated air entering the lower inlet vent from the space communicates to the internal compartment to be treated by the at least one component, that changes a characteristic of the air; and b) treated air is communicated through the upper outlet vent back into the space.

The upper outlet and lower inlet vents may each be in the form of a plurality of discrete slits.

In one form, the animal has a head and the upper outlet vent is at the head of the animal.

In one form, the housing defines an internal compartment within which the at least one component resides. The air purifier further has an air moving mechanism. The housing has inlet and outlet vents in communication with the internal compartment so that: a) untreated air from the space is caused to be moved by the air moving mechanism through the inlet vent to the internal compartment, where the air is treated by the at least one component that changes a characteristic of the air; and b) treated air from the internal compartment is caused to be communicated through the outlet vent back to the space.

The air moving mechanism may be in the form of a fan.

In one form, the housing is shaped to simulate the appearance of an animal with a head, a tail/feet, and a torso with a back and an abdomen. The air purifier further has a control element that is exposed on the housing and operable by a user to change a state of the air moving mechanism.

The control element may be in the form of a repositionable knob exposed at the animal's abdomen.

In one form, the housing has a top and bottom, with the head of the animal at the top of the housing and the tail/feet of the animal at the bottom of the housing to give an appearance that the animal is standing upright on the tail/feet.

In one form, the at least one component is in the form of a material through which air in the space passes to cause the at least one component to change a characteristic of the air.

In another form, the at least one component is in the form of a source that generates light to which air from the space is exposed to change a characteristic of the air.

In one form, the housing has a main housing assembly and sub-housing assembly that is separable from the main housing assembly. The sub-housing assembly defines a sub-compartment for the at least one component that is separable as a unit with the sub-housing assembly from the main housing assembly.

In one form, the housing has a first separable cover that defines a part of the external surface that is shaped to simulate the appearance of an animate object. The first separable cover has an assembled state and a separated state. The sub-housing assembly is: a) separable from the main housing assembly with the first separable cover in the separated state; and b) blocked from being separated from the main housing assembly with the first separable cover in the assembled state.

In one form, the housing defines an internal compartment within which the at least one component resides and further has a second separable cover that defines a part of the external surface that is shaped to simulate the appearance of an animate object. The second separable cover is changeable from an assembled state into a separated state wherein access can be gained to the internal compartment.

In one form, at least one of the first and second separable covers is: a) maintained in its assembled state; and b) changed between its assembled and separated states without requiring use of any separate fasteners.

In one form, the tail/feet defines an enlarged, downwardly facing surface to stably support the air purifier upon an upwardly facing surface.

In one form, the animate object is an animal having a head, a tail/feet, and a torso with an abdomen and a back. The first separable cover defines a part of the back of the animal, with the second separable cover defining a part of the head of the animal such that with the second separable cover in its separated state, it appears that a part of the animal's head is removed.

In one form, the tail/feet has a downwardly facing surface through which the air purifier is supported upon an upwardly facing surface to give an appearance that the animal is standing upright and the tail/feet is directly situated upon an underlying, upwardly facing surface.

In one form; the air purifier has a top and bottom, with the head at the top of the air purifier and the tail/feet at the bottom of the air purifier.

In one form, there is no structure on the housing below the tail/feet to give an appearance that the animal is standing upright on the tail/feet directly upon an underlying, upwardly facing surface.

In one form, there is no structure on the housing above the head.

In one form, the housing has a peripheral wall extending around a vertical axis and the housing external surface is shaped to simulate the appearance of an animate object substantially fully around the peripheral wall.

In one form, the animate object is an animal and the external surface has discrete projections that are each shaped to simulate a body part of the animal.

In one form, the body part is at least one of: a) a tail/feet; b) a nose; c) a fin; and d) a flipper.

### BRIEF DESCRIPTION OF THE DRAWINGS

FIG. 1 is a schematic representation of one form of air purifier, according to the present invention;

FIG. 2 is a side elevation view of a specific form of air purifier, as in FIG. 1, and having a housing that is shaped to simulate the appearance of a shark;

FIG. 3 is a front elevation view of the air purifier in FIG. 2;

FIG. 4 is a rear elevation view of the air purifier in FIG. 2;

FIG. 5 is a top, plan view of the air purifier in FIG. 2;

FIG. 6 is a bottom view of the air purifier in FIG. 2;

FIG. 7 is an exploded, perspective view of the air purifier in FIGS. 2-6;

FIG. 8 is an enlarged, cross-sectional view of the air purifier taken along lines 8-8 of FIG. 5;

FIG. 9 is a perspective view of a modified form of air purifier, according to the invention, with a housing having an external surface shaped to simulate the appearance of a killer whale;

FIG. 10 is a perspective view of a modified form of air purifier, according to the invention, with a housing having an external surface shaped to simulate the appearance of a dolphin; and

FIG. 11 is a perspective view of a modified form of air purifier, according to the invention, with a housing having an external surface shaped to simulate the appearance of a penguin.

### DETAILED DESCRIPTION OF THE DRAWINGS

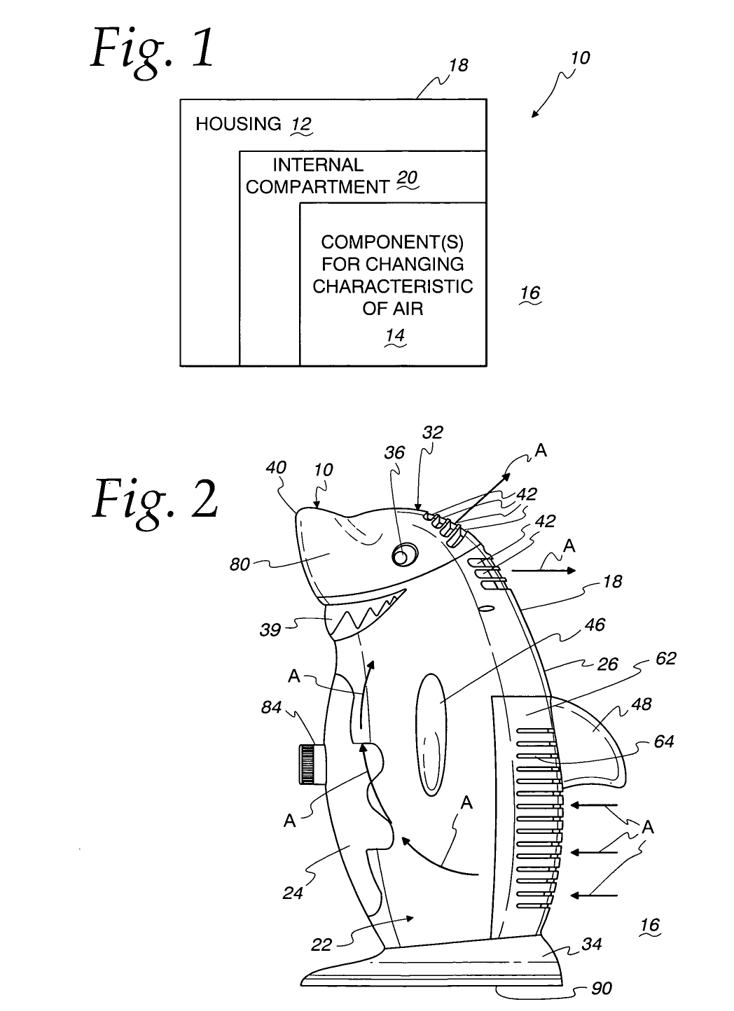

In FIG. 1, a schematic representation of an air purifier, according to the present invention, is shown at 10. The air purifier 10 consists of a housing 12 with an associated component(s) 14 for changing a characteristic of air in a space 16 within which the air purifier 10 resides. The housing 12 has an external surface 18 that is shaped to simulate the appearance of an animate object.

The air purifier 10 is shown in schematic form in FIG. 1 to generically encompass the many variations contemplated by the invention. The animate object that is simulated is not limited in nature and may be an animal, such as one that lives in water or around water. In the former case, the animal may be a fish or a mammal. In the latter case, the animal may be a penguin. As used herein, “animal” is intended to encompass any living being that is commonly recognized by the general public by reason of its shape/appearance. The word “animal” is also intended to encompass animals living primarily on land as well as those capable of flying.

It is an aim of the present invention to provide a self-contained air purifier with the capability of changing a characteristic of air that also has a physical appearance that is particularly attractive to young children. The housing 12 can be constructed so that the entire external surface 18 thereof is shaped to simulate the appearance of a particular animal so that it is attractive to young children, as are common toys that similarly simulate the appearance of animals.

The air purifier 10 is also shown schematically in FIG. 1 to generically encompass air purifying components, in any form or combination, in association with/on the housing 12. While not so limited, the component(s) 14 is preferably resident within an internal compartment 20 defined by the housing 12.

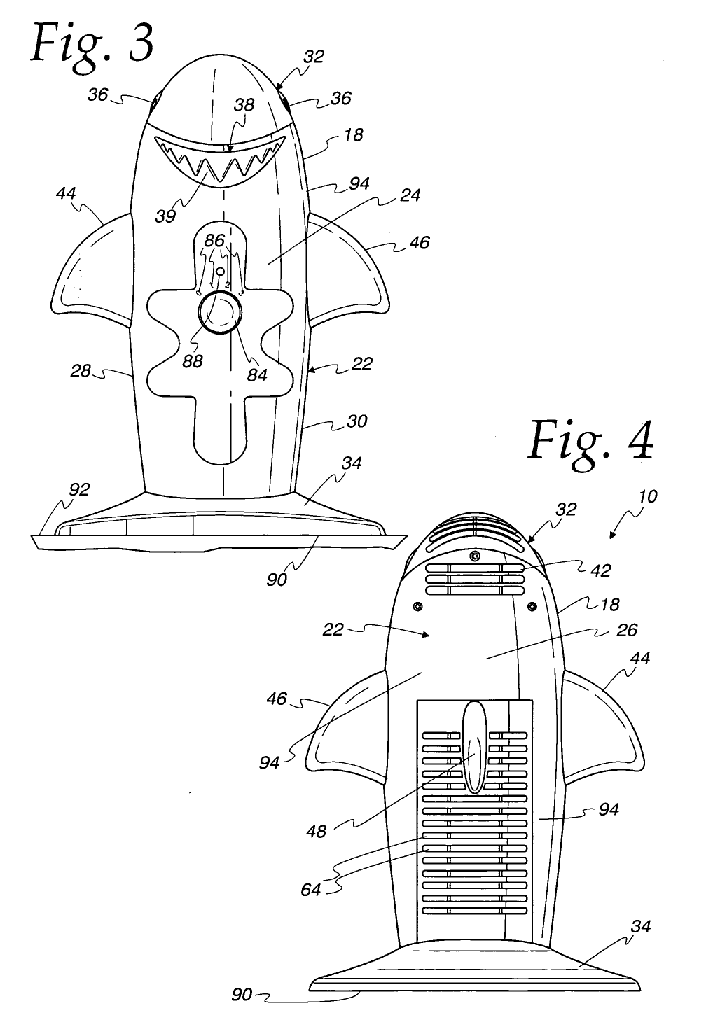

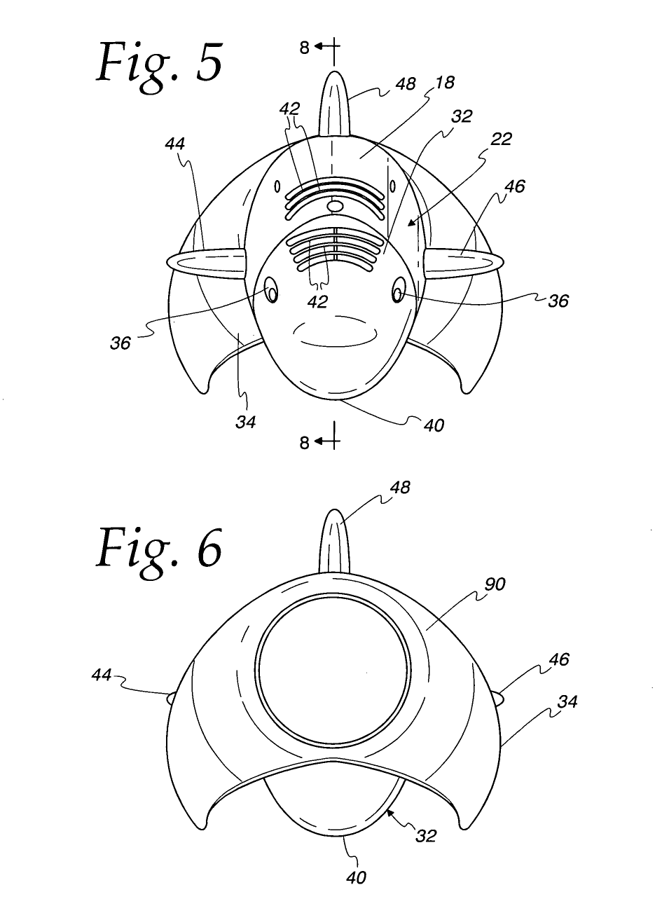

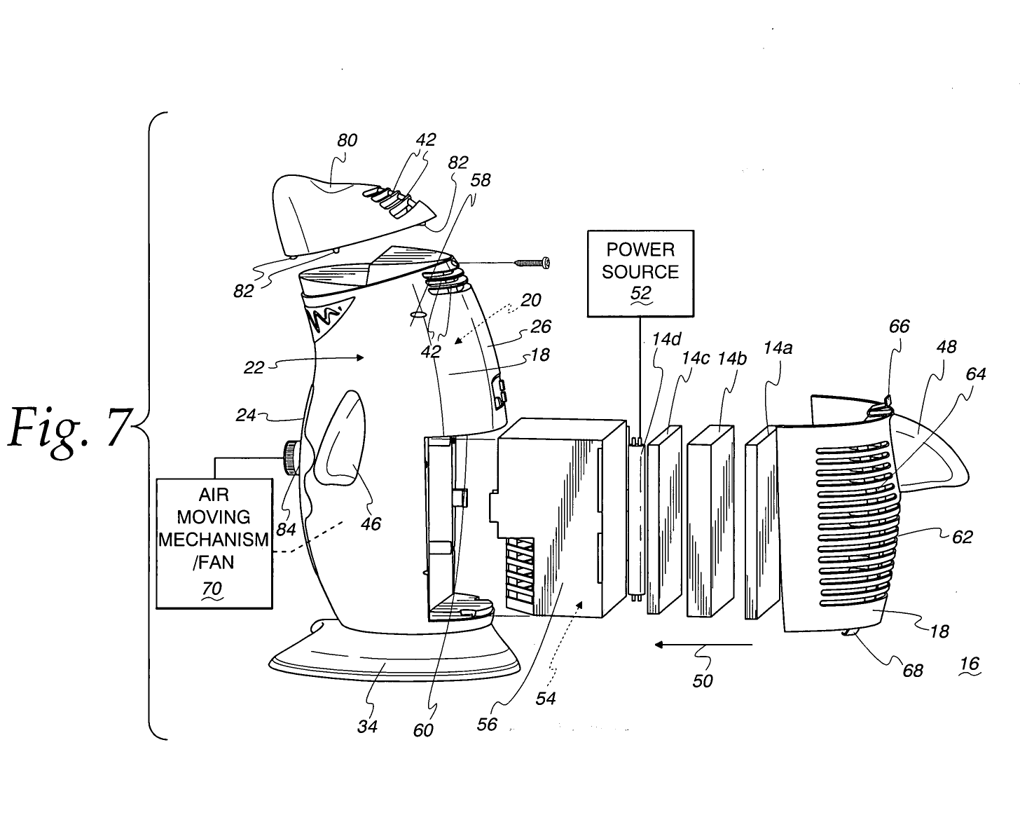

One specific form of “animal” is shown in FIGS. 2-8, wherein the external surface 18 is shaped to simulate the appearance of a shark. As noted above, this particular configuration is exemplary in nature only and used herein for purposes of explaining the inventive concept.

The external surface 18 on the air purifier 10 is shaped to simulate discrete, identifiable shark parts, including a torso 22 with a front/abdomen 24, a back 26 and opposite sides 28, 30. A head 32 is provided on the top of the torso 22, with a tail 34 provided on the bottom of the torso 22. For purposes of generic description of both land and water habitating animals, the tail 34 will be characterized as a “tail/feet” herein.

The head 32 has recognizable, discrete features, including eyes 36, a mouth at 38, with identifiable teeth 39. The head 32 also has a discrete, projecting nose/snout 40. The housing 12 has a series of curved, generally parallel, slits 42 on the head 32, which may be situated to simulate gills and also function as an upper air outlet vent, as hereinafter explained.

Each side 28, 30 of the torso 22 has a discrete, laterally projecting fin 44, 46, respectively, with the back 26 having a discrete, rearwardly projecting dorsal fin 48.

In addition to shaping the external surface 18 to simulate the various shark parts, the external surface 18 may be strategically colored or textured to highlight these parts. For example, the abdomen 24, eyes 36, and teeth 39 are shown with contrasting color/texture to highlight the same.

The housing 12 has a generally hollow construction to define the internal compartment 20 that extends substantially from the tail/feet 34 to the top of the head 32.

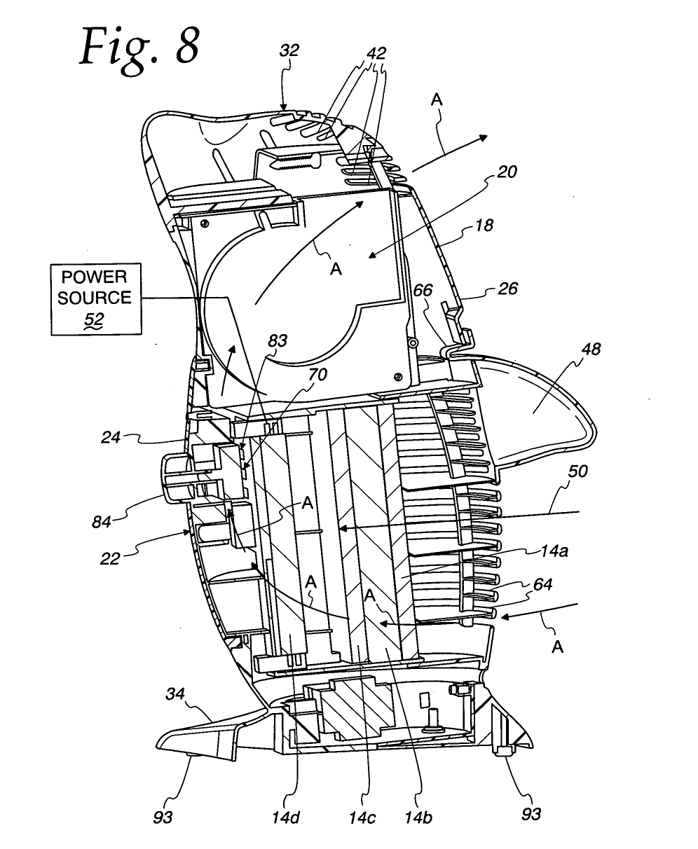

In this embodiment, there is a plurality of internal filtering components 14a, 14b, 14c, 14d. As noted previously, the number and configuration of these components 14a-14d is not critical to the present invention. In this embodiment, the component 14a is a primary filter made of material well known to those skilled in the art to intercept and accumulate particles of a relatively large dimension. The component 14b is a HEPA filter with activated carbon particles therein. The component 14c is made with a TiO₂ photocatalyst. As shown in FIGS. 7 and 8, these components have a generally squared shape and are stackable, one against the other to produce a unitary composition through which air from the space 16 passes, generally in the direction of the arrow 50, whereby a characteristic of the air is changed by, in this case, being purified by removing individual, entrained components of the type that each of the purifying components 14a-c is designed to intercept and contain.

The purifying component 14d is a source of ultraviolet light. In this case, the component 14d consists of a lamp that is operated by an appropriate power source 52 that may be within the internal compartment 20 or outside thereof, such as a conventional household power supply or a separate battery pack. The light from the ultraviolet lamp is known to kill certain airborne germs that are potentially harmful to humans.

The components 14a-d can be mounted within a sub-compartment 54 defined by a sub-housing assembly 56 that fits within a main housing assembly 58. The sub-housing assembly 56 and main housing assembly 58 together make up the housing 12.

In this embodiment, the back 26 and sides 28, 30 have a cut-out 60 to provide an access opening through which the sub-housing assembly 56 can be directed from rear to front into an operative position and from front to rear to be separated from the main housing assembly 58, as to allow installation, removal, inspection, replacement and/or maintenance of the components 14a-14d. The sub-housing assembly 56 is translatable guidingly relative to the main housing assembly 58 between its operative and separated positions.

A forwardly opening, U-shaped, separable cover 62 can be installed over the cutout 60 with the sub-housing assembly 56 and purifying components 14a-14d operatively assembled. The cover 62 defines part of the external surface 18 and preferably blends with the remainder of the external surface 18 so that it is not obviously detectable as a separate component. In this case, the cover 62 has a single piece that forms the projecting dorsal fin 48. The cover 62 also has a series of generally parallel slits 64 at both sides of the fin 48, cooperatively defining a bottom inlet vent for air within the space 16.

Preferably, the cover 62 has top and bottom clips 66, 68 which snap connect to the main housing assembly 58 to allow the cover 62 to be selectively placed and maintained in an assembled state, and changed into a fully separated state, without requiring the use of any separate fasteners.

An air moving mechanism 70 is provided at the front of the internal compartment 20. The precise form of the air moving mechanism 70 is not critical to the present invention. It suffices that the air moving mechanism 70 be capable of inducing forward flow of air, as indicated by the arrows A, from the space 16 to and through/past the air purifying components 14a-14d and into the internal compartment 20, whereupon treated air is directed upwardly through the slits 42 to be recirculated back into the space 16. The air moving mechanism 70 may be in the form of a fan with an impeller or may alternatively use other means such as temperature difference or electrostatic attraction to induce air flow.

In this embodiment, a separate cover 80 defines part of the head 32 and is changeable between an assembled state and a separated state, preferably without requiring the use of separate fasteners. A snap fit connection with clips 82 may be used for this purpose. With the cover 80 in the separated state, it appears as if a part of the head 32 is removed the internal compartment 20 is exposed from above to allow access to the air moving mechanism/fan 70, and generally to the entire region of the internal compartment 20, as to allow cleaning thereof and/or maintenance thereto.

In an assembled state, with the air moving mechanism/fan 70 operated, air from the space 16 is caused to flow, as indicated by the arrows A, into and through the lower inlet vent, defined by the slits 64, through and past the purifying components 14a-14d, and fully through the internal compartment 20 and upwardly therefrom through the upper vent, defined by the slits 42, for recirculation after treatment back into the space 16. Preferably, the moving air volume can be changed by changing the state of the air moving mechanism/fan 70 as through an appropriate control 83 that can be operated by an external component 84, in this case shown as a rotary knob 84 located at the abdomen 24. Numerical indicia 86 give a visual indication of the position of the knob 84 and thereby state of the control 83. An LED 88 may also be provided to identify another state of the control, i.e. on/off, etc.

In this embodiment, the tail/feet 34 defines a downwardly facing surface 90 with an enlarged area that can be placed directly against an upwardly facing support surface 92, or spaced slightly thereabove by pads 93 (FIG. 8). By supporting the air purifier 10 in this manner, one is given the appearance that the shark is standing upright on its tail/feet 34 directly on the surface 92. By reason of having the head 32 and tail/feet 34 defining the upper and lower extremities of the air purifier 10, the entire unit has the appearance of the animal/shark. Thus, it appears potentially as a self-contained toy that is attractive, particularly to young children. In this case, the external surface 18 on a peripheral wall 94, extending fully around the vertical axis for the air purifier 10, is shaped to simulate the appearance of a shark so that from virtually every perspective, the air purifier 10 has the appearance of a shark.

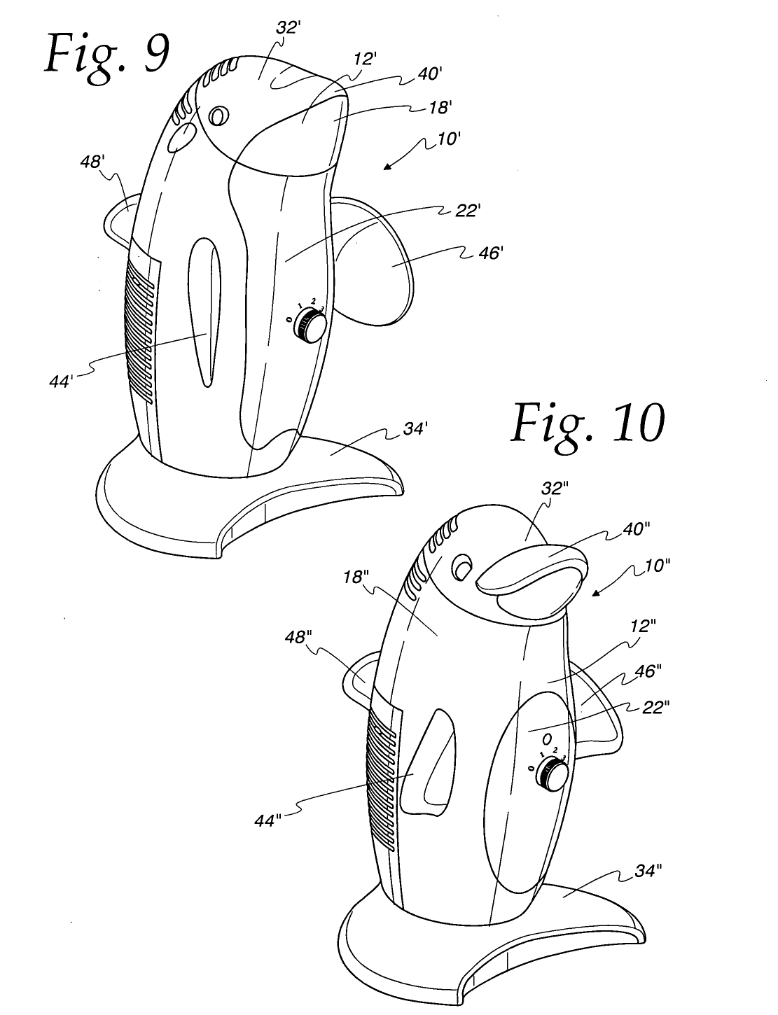

As an alternative to a shark, a modified form of air purifier, as shown at 10′ in FIG. 9, has a housing 12′ with an external surface 18′ that is shaped to simulate the appearance of a killer whale with a corresponding torso 22′ with a head 32′ and tail/feet 34′. The housing 12′ has discrete, projecting body parts, in this case including, but not limited to, a nose/snout 40′, a dorsal fin 48′, side fins 44′, 46′, and the aforementioned tail/feet 34′. The air purifier 10′ operates in substantially the same manner as the air purifier 10, previously described.

A further modified form of air purifier is shown at 10″ in FIG. 10, and has a housing 12″ with an external surface 18″ that is shaped to simulate the appearance of a dolphin. The dolphin has a corresponding torso 22″ with a head 32″ and tail/feet 34″ at its vertical extremities. The housing 12″ has discrete, projecting body parts, including a nose/snout 40″, a dorsal fin 48″, side fins 44″, 46″, and the aforementioned tail/feet 34″. The air purifier 10″ operates in the same manner as does the air purifier 10, as previously described.

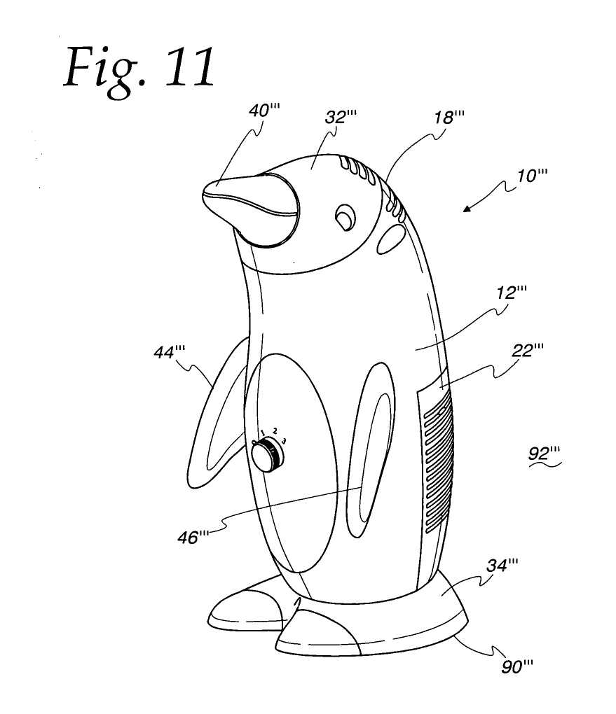

A further modified form of air purifier is shown at 10′″ in FIG. 11. The air purifier 10′″ has a housing 12′″ with an external surface 18′″ that is shaped to simulate the appearance of a penguin. The penguin has a corresponding torso 22′″ and a head 32′″ and tail/feet 34′″, respectively at the top and bottom thereof. The tail/feet 34′″ define an enlarged, downwardly facing surface 90′″ to facilitate support in an upright orientation upon an upwardly facing surface 92′″. The housing 12′″ has discrete, projecting body parts, including a nose/snout 40′″, side fins/arms 44′″, 46′″, and the aforementioned tail/feet 34′″. The air purifier 10′″ functions in the same manner as the air purifier 10.

The foregoing disclosure of specific embodiments is intended to be illustrative of the broad concepts comprehended by the invention.

1. A purifier for air comprising:
a housing; and
at least one component on the housing for changing a characteristic of air in a space within which the air purifier resides,
the housing having a top and bottom, a front and back, and an external surface that is shaped to simulate the appearance of an animate object having a head, a tail/feet and a torso with a back and an abdomen.
the head of the animate object at the top of the housing and the tail/feet of the animate object at the bottom of the housing to give an appearance that the animate object is standing upright on the tail/feet.
wherein the housing defines an internal compartment within which the at least one component resides at the simulated torso.
the housing having a lower inlet vent and an upper outlet vent each in communication with the internal compartment so that: a) untreated air entering the lower inlet vent from the space communicates to the internal compartment to be treated by the at least one component: and b) treated air is communicated through the upper outlet vent back into the space.

2. The air purifier according to claim 1 wherein the housing is shaped to simulate the appearance of an animal.

3. The air purifier according to claim 1 wherein the housing is shaped to simulate the appearance of an animal that lives in water.

4. The air purifier according to claim 1 wherein the housing is shaped to simulate the appearance of an animal that lives around water.

5. (canceled)

6. The air purifier according to claim 2 wherein the animal is one of a) a shark; b) a whale; and c) a penguin.

7. (canceled)

8. The air purifier according to claim 1 wherein the upper outlet vent comprises a plurality of discrete slits.

9. The air purifier according to claim 1 wherein the upper outlet and lower inlet vents each comprises a plurality of discrete slits.

10. The air purifier according to claim 1 wherein the animal has a head and the upper outlet vent is at the head of the animal at the back of the housing.

11. The air purifier according to claim 1 wherein the air purifier further comprises an air moving mechanism, and the housing inlet and outlet vents are each in communication with the internal compartment so that: a) untreated air from the space is caused to be moved by the air moving mechanism through the inlet vent to the internal compartment where the air is treated by the at least one component that changes a characteristic of the air; and b) treated air from the internal compartment is caused to be communicated through the outlet vent back to the space.

12. The air purifier according to claim 11 wherein the air moving mechanism comprises a fan.

13. The air purifier according to claim 11 wherein the air purifier further comprises a control element that is exposed on the housing and operable by a user to change a state of the air moving mechanism.

14. The air purifier according to claim 13 wherein the control element comprises a repositionable knob exposed on the animal's abdomen.

15. (canceled)

16. The air purifier according to claim 1 wherein the at least one component comprises a material through which air in the space passes to cause the at least one component to change a characteristic of the air.

17. The air purifier according to claim 1 wherein the at least one component comprises a source that generates light to which air from the space is exposed to change a characteristic of the air.

18. The air purifier according to claim 1 wherein the housing comprises a main housing assembly and a sub-housing assembly that is separable from the main housing assembly, the sub-housing assembly defining a sub-compartment for the at least one component that is separable as a unit with the sub-housing assembly from the main housing assembly.

19. The air purifier according to claim 18 wherein the housing comprises a first separable cover that defines part of the external surface that is shaped to simulate the appearance of an animate object and having assembled and separated states, the sub-housing assembly: a) separable from the main housing assembly with the first separable cover in the separated state; and b) blocked from being separated from the main housing assembly with the first separable cover in the assembled state.

20. The air purifier according to claim 19 wherein the housing defines an internal compartment within which the at least one component resides and further comprises a second separable cover that defines a part of the external surface that is shaped to simulate the appearance of an animate object, the second separable cover changeable from an assembled state into a separated state wherein access can be gained to the internal compartment.

21. The air purifier according to claim 20 wherein at least one of the first and second separable covers can be: a) maintained in its assembled state; and b) changed between its assembled and separated states without requiring use of any separate fasteners.

22. The air purifier according to claim 15 wherein the tail/feet defines an enlarged, downwardly facing surface to stably support the air purifier upon an upwardly facing surface.

23. The air purifier according to claim 21 wherein the first separable cover defines a part of the back of the animal and the second separable cover defines a part of the head of the animal such that with the second separable cover in its separated state, it appears that a part of the animal's head is removed.

24. (canceled)

25. (canceled)

26. The air purifier according to claim 1 wherein there is no structure on the housing below the tail/feet to thereby give an appearance that the animal is standing upright on the tail/feet directly upon an underlying, upwardly facing surface.

27. The air purifier according to claim 1 wherein there is no structure on the housing above the head.

28. The air purifier according to claim 27 wherein the housing has a peripheral wall extending around a vertical axis and the housing external surface is shaped to simulate the appearance of an animate object substantially fully around the peripheral wall.

29. The air purifier according to claim 20 wherein the animate object is an animal and the external surface has a discrete projection shaped to simulate a body part of the animal on the first separable cover that can be grasped to function as a handle.

30. The air purifier according to claim 29 wherein the body part is at least one of: a) a tail/feet; b) a nose; c) a fin; and d) a flipper.

31. The air purifier according to claim 1 wherein the simulated abdomen comprises a front surface that is convexly curved and the air moving between the inlet and outlet vents moves in a curved path corresponding to the convexly curved front surface.

32. The air purifier according to claim 9 wherein the upper outlet is at the back of the housing.
